(19) United States
(12) Patent Application Publication
(10) Pub. No.: US 2007/0123344 A1
(43) Pub. Date: May 31, 2007

(54) Slot machine

(76) Inventor: Nabil N. Ghaly JR., South Huntington, NY (US)

Correspondence Address: NABIL N. GHALY, 14 Longwood Drive, South Huntington, NY, 11746, US

(21) Appl. No.: 11/605,717

(22) Filed: Nov. 30, 2006

Related U.S. Application Data
(63) Continuation of application No. 60/740,529, filed on Nov. 30, 2005.

(51) Int. Cl. A63F 13/00; A63F 9/24

(52) U.S. Cl. 463/20

(57) ABSTRACT

In a gaming device that employs a plurality of winning lines, means to select one or a plurality of wining lines at random.

### PARENT CASE TEXT

This utility application benefits from provisional application of U.S. Ser. No. 60/740,529, filed on Nov. 30, 2005.

### BACKGROUND OF THE INVENTION

This invention relates generally to slot machines, also known as coin operated gaming machines, and more specifically to a category of slot machines that employ a plurality of winning lines, also referred to as pay lines.

Slot machines are well known, and have been around for many years. A traditional mechanical slot machine includes a plurality of symbols that are mapped on the periphery of a plurality of rotating reels. The reels are randomly stopped and a win decision is made based on the combination of symbols stopping at a single winning line, or a plurality of winning lines. Alternatively, a video slot machine employs a CRT or an LCD screen, or the like, to provide a graphic display of simulated rotating reels. Similar to traditional mechanical machines, the simulated reels are stopped at random, and a win decision is made based on the combination of symbols stopping at a single winning line, or a plurality of wining lines.

In both of the above described types, and when a plurality of winning lines are provided, the player is required to deposit a wager for each winning line selected. Normally, the selection of the winning lines is done sequentially, and is based on the number of coins or wagers deposited. The player has also an option to place a maximum bet, and in such case all available winning lines are selected. Further, in certain machines there is a sizable jackpot prize that is normally reserved for the highest ordered winning line. This means that a player must select all winning lines in order to bet on said jackpot prize. The slot machine described in this invention incorporates a new feature that enables a player to randomly select one or a plurality of winnings lines from the total available winning lines before the start of game play. Further, as an optional feature, a jackpot prize could be randomly assigned to a winning line.

### OBJECT OF THE INVENTION

Because it is desirable to offer players new slot machine features, it is an object of this invention to provide a coin operated gaming device that enables a player to randomly select one or a plurality of winning lines from the total number of available winning lines.

It is another object of this invention to provide a slot machine that enables a player to bet on a jackpot without betting on all the winning lines by randomly selecting a number of winning lines from the total available winning lines.

It is a further object of this invention to provide a slot machine that enables a player to define the number of winning lines desired, rather than requiring a player to select specific winning lines for a particular game.

It is also an object of this invention to provide a slot machine that enables a player to define the number of winning lines desired, as well as the number of coins or wagers per line.

It is still an object of the current invention to provide a slot machine that employs a plurality of winning lines, and also has a sizable jackpot, and wherein said jackpot is randomly assigned to one of said plurality of winning lines for each game.

It is another object of this invention to provide a coin operated gaming machine, which incorporates a variety of visual and audible indications to heighten the enjoyment of play.

### SUMMARY OF THE INVENTION

The foregoing and other objects of the invention are accomplished by an interactive slot machine that has a plurality of wining lines, and which incorporates an input control mechanism that enables a player to select the number of desired winning lines for a game without identifying specific winning lines. The control program then selects the desired number of winning lines at random from the total number of available winning lines.

In accordance with a preferred embodiment of the invention, this new feature is provided for a video slot machine that employs five rotating reels, and nine (9) winning lines. A player can select from one to eight winning lines at random using an entry control mechanism before the start of game play. Obviously the player can still elect to bet on a particular line or lines, or to place a maximum bet that activates all winning lines. To implement this feature, the slot machine described in the preferred embodiment incorporates one switch mechanism that has two positions: “NORMAL” and “RANDOM.” If the player selects the normal setting, then the slot machine operates similar to a conventional machine where a player selects the individual winning lines by progressively depositing coins or wagers. For example, if the player wishes to bet on lines 1, 2 & 3, he or she needs to deposit three coins. To bet on line 4, he or she needs to deposit a forth coin, and so on. In a conventional machine, a player cannot bet on line number 4 before betting on lines 1, 2 & 3.

Alternatively, if the random setting is selected, then the depositing of a coin or a wager results in the selection of a line. The specific line is identified at random after the activation of the start lever or button. As an example, if the player wishes to bet on three lines, then he or she must deposit three coins or wagers, and in such case the device will randomly select three lines out of the available nine lines at the beginning of the game. These lines do not have to be consecutive as in a conventional machine. For example, the control program could select lines 3, 4 & 8, in response to a three lines selection by the player. A winning decision is then made if one or more winning combinations of symbols occur at the randomly selected lines 3, 4 & 8.

To operate the slot machine, the player is provided with conventional control switches, such as the BET ONE, BET MAX, COINS PER LINE, and COLLECT buttons.

Because certain slot machines incorporate a large jackpot that is normally associated with the highest ordered winning line, the current invention includes an optional feature that randomly assigns the jackpot prize to one of the available nine winning lines. Such random assignment is activated when the winning line selection switch is set at random. In such case, there are two conditions necessary to winning the jackpot price. First, one of the randomly selected winning lines must match the winning line that was randomly assigned to the jackpot prize; and, second, the winning symbol combination required for the jackpot price must occur at that winning line.

It should be noted that the use of a video slot machine for the preferred embodiment is being disclosed solely for the purpose of describing the preferred embodiment, and is not intended to limit the invention hereto. As would be appreciated by a person skilled in the art, this invention could be also implemented by a mechanical reel slot machine that employs a plurality of winning lines.

### BRIEF DESCRIPTION OF THE DRAWINGS

These and other more detailed and specific objectives will be disclosed in the course of the following description taken in conjunction with the accompanying drawings wherein:

FIG. 1 is a perspective view of the preferred embodiment of a coin operated gaming machine according to the invention.

FIG. 2 indicates a block diagram of the microprocessor circuitry used to control the gaming machine according to the invention.

FIGS. 3-4 indicate a logical flow diagram that illustrates the main program functions performed by the microprocessor controlling the gaming machine according to the invention.

FIG. 5 shows an example of three (3) randomly selected pay lines, and a pay line that was randomly assigned to a jackpot prize.

### DESCRIPTION OF THE PREFERRED EMBODIMENT

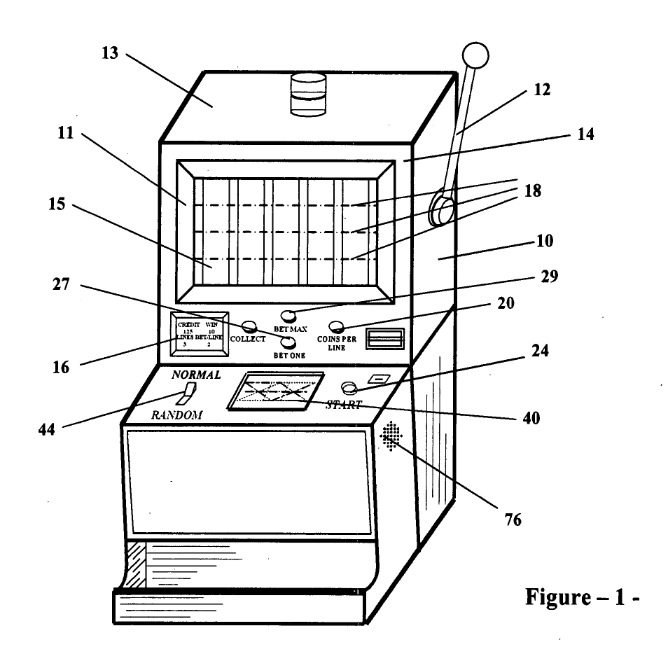

Referring now to the drawings where the illustrations are for the purpose of describing the preferred embodiment of the invention and are not intended to limit the invention hereto, FIG. 1 is a front prospective view of a slot machine 10, which is comprised of a housing 13 having a face 14 and a video screen 11 that provides a graphic display of five rotating reels 15. The size of the screen is such that at least three positions 18 on each reel are visible to the player. Overall, the symbols at fifteen playing positions are indicated on the screen. The preferred embodiment provides a total of nine (9) winning lines, which could be indicated on the external surface of the screen. The slot machine 10, also, has conventional controls including an activation lever 12, a start button 24, “BET ONE” 27, “BET MAX” 29 and “COINS PER LINE” 20 buttons. Further, the preferred embodiment includes a Liquid Crystal Display (LCD) screen 16, which provides game information to the player that includes the number of lines selected, coins per line, number of coins won, and balance of remaining coins or credit.

In addition, the preferred embodiment employs a winning lines selection switch 44 to enable a player to select between conventional (“normal”) line selection, and random line selection. This switch has two positions, identified as “NORMAL” and “RANDOM.”

When the winning lines selection switch 44 is set to the “NORMAL” position, the slot machine operates as a conventional machine, wherein the selection and activation of the winning lines is based on a sequential and progressive protocol. Said selection and activation of winning lines is implemented by the depositing of coins or wagers such that the first credit corresponds to line 1, the second credit corresponds to line 2, the third credit corresponds to line 3, etc.

Alternatively, if the winning lines selection switch 44 is set to the “RANDOM” position, then the number of credits deposited by the player represents only the number of winning lines desired, and does not select or activate specific, or designated winning lines. After the activation of the start button 24, or lever 12, the microprocessor, under the direction of the control program, randomly selects specific winning lines to activate the desired number of lines.

The preferred embodiment, also, includes an optional feature that is activated by the random setting of the winning lines selection switch 44. Under such setting, when the slot machine employs a jackpot prize, the control program randomly assigns the jackpot prize to a winning line. Obviously, such random assignment of a jackpot prize could be activated by a separate switch, or the assignment could be fixed to a specific winning line as is the case with conventional machines.

The preferred embodiment, also, includes a second LCD screen 40 that indicates the randomly selected winning lines immediately after the activation of the start lever 12 or button 24. This LCD also indicates to the player the winning line associated with a jackpot prize.

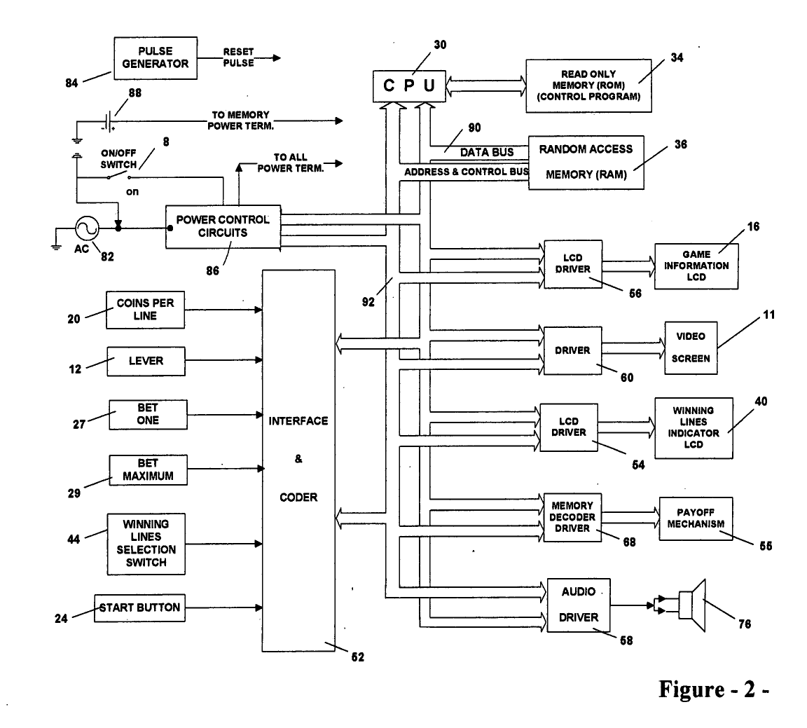

A block diagram of the control circuitry to operate this gaming device 10 is illustrated in FIG. 2. This block diagram includes a micro-controller with a central processing unit (CPU) 30 and system memory. The system memory preferably comprises a separate read-only memory (ROM) 34 and battery-backed random-access memory (RAM) 36. It will be appreciated, however, that the system memory may be implemented on any of several alternative types of memory structures or may be implemented on a single memory structure. For example, the read-only memory 34 may be replaced or supplemented with a mass storage unit such as a removable flash memory or a hard drive. The system memory is used to store game-related data associated with the chance games played on the slot machine. The game-related data may, for example, include game code, math tables, a random number generator, and audio resources.

An on/off toggle switch 8 is provided to control the operational state of the gaming machine and the connection of the external AC power supply 82 to the electric circuitry. Also, an interface and coding device 52 is used as an input interface between the various control elements and the CPU 30. These control elements include the winning lines selection switch 44, main lever switch 12, “BET ONE” switch 27, “BET MAX” switch 29, “START” button 24, “COINS PER LINE” switch 20 and other conventional control elements of a slot machine. Similarly an LCD control driver 56 and an audio driver 58 are used to interface the LCD screen that provides game information 16, and the audio circuits that activate the loudspeaker 76 with the CPU 30. A second LCD driver 54 is used to interface the CPU with the LCD screen 40 that indicates the randomly selected winning lines. Also, a driver 60 is used to interface the video screen 11 with the CPU 30. A common address and control bus 92, and a separate common data bus 90 are used to interconnect the central processing unit 30 with the interface and coding device 52, the video driver 60, the LCD drivers 54 & 56, the audio driver 58, the read only memory (ROM) 34, and the random access memory (RAM) 36.

Prior to selecting the amount of a wager, the player may select a setting for the winning lines selection switch 44. The player may select an amount to wager and other game play functions via the button control panel that includes “BET ONE” 27, “BET MAX” 29, and “COINS PER LINE” 20 buttons. If the random setting is selected, the wager amount is signaled to the CPU 30 by a coin/credit detector. In response to the wager, the CPU 30, under the direction of the control program, executes a segment of the game code that, based on a randomly selected outcome, selects a number of winning lines equivalent to the deposited wager, taking into account the number of coins per line. The number of lines will be indicated on the information screen 16, and the randomly selected lines will be indicated on a second LCD screen 40. A second segment of the game code controls the rotation and stopping of the simulated reels. Following the stopping of the reels, the CPU 30, under the direction of the control program, executes a segment of the game code (control logic) that determines if one or more winning combinations of symbols occurred at the randomly selected winning lines. Also, the CPU 30 selectively accesses the audio resources to be played through one or more audio speakers 76 mounted to a housing of the slot machine. If the outcome after the movement of the reels corresponds to a winning combination outcome identified on a pay table, the CPU 30 instructs a payoff mechanism 55 to award the player a payoff for that winning outcome combination in the form of coins or credits.

Referring again to FIG. 2, in order to operate the gaming device, the ON-OFF switch 8 should be activated from the “off” position to the “on” position, which causes power to be supplied from the main external power supply 82 to the power control circuits 86, which in turn energizes all terminals of the gaming device 10. The gaming device also includes a rechargeable battery 88, which feeds the memory power terminals in order to ensure that critical data is not lost in the event of a loss of the external electrical supply 82.

It should be noted that the above description of the block diagram illustrated in FIG. 2, and using interface and coding devices, and memory decoding devices, is being provided for the purpose of describing the preferred embodiment, and is not intended to limit the invention herein. As would be appreciated by a person skilled in the art, a game designer may elect a microprocessor that includes input and output ports to interface input switches, and output devices with the CPU. Such microprocessors are well known in the art.

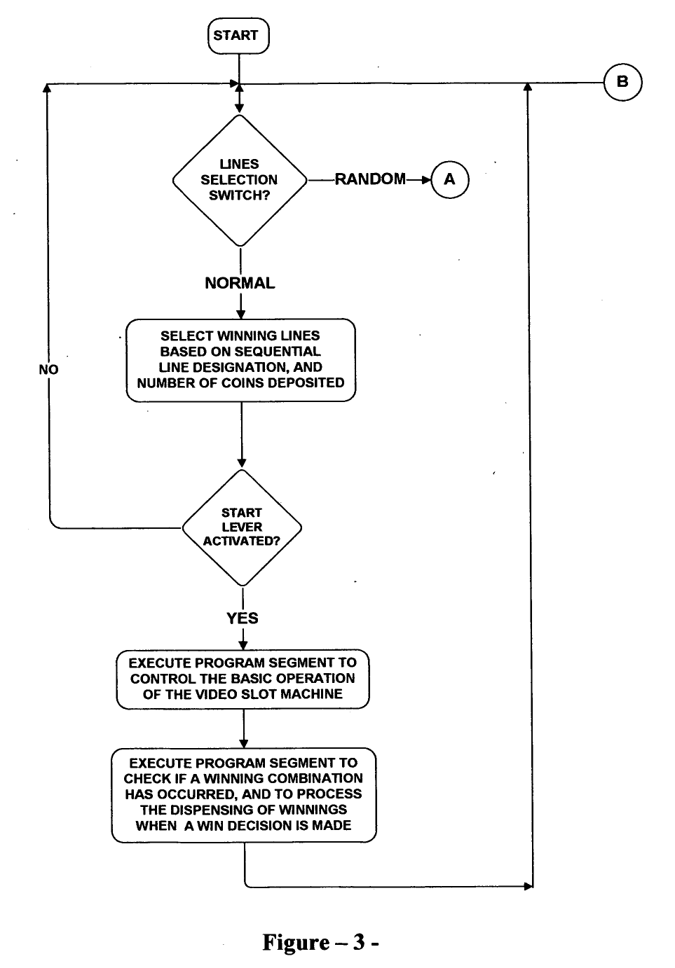

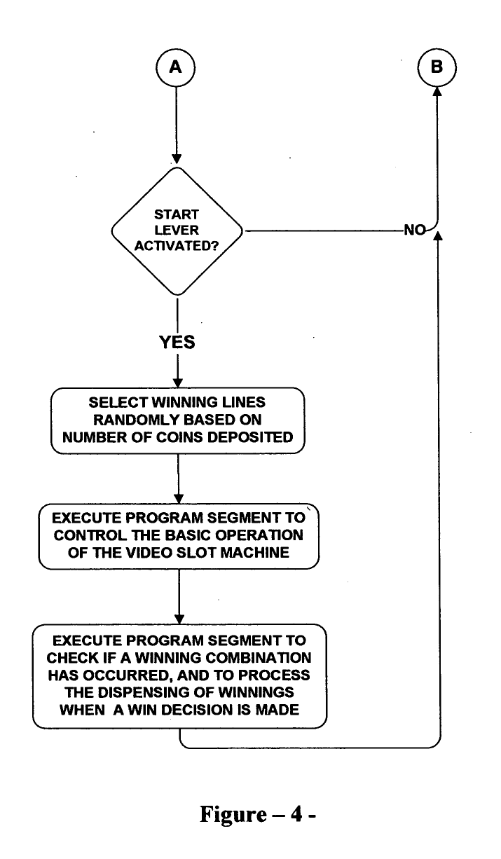

With respect to the operation of this gaming machine, the logic steps utilized are illustrated in flow diagram form in FIGS. 3-4, which interconnect with each other at the places shown in the various figures. Even though specific reference will not be made to this diagram in the following description of the operation of the slot machine, periodic reference to this diagram may prove to be helpful to the reader hereof.

Upon the activation of the “On-Off” switch 8, and the initialization of the program variables, the interactive slot machine is ready to operate. The player is expected to deposit a wager, and activate the winning lines selection switch 44 prior to the activation of the start button or lever. If this switch is set to the “NORMAL” position, the slot machine operates as a conventional gaming device. The game control logic activates consecutive winning lines in a predefined order based on the number of coins or wagers deposited. Such activation occurs prior to the activation of the start button 24 or lever 12.

Alternatively, if the switch is set to the “RANDOM” position, then upon depositing the desired wager, the information LCD screen 16 indicates to the player the number of lines selected. The identification and selection of the winning lines do not take place until after the activation of the start button 24 or lever 12. The randomly selected lines are then indicated on the second LCD screen 40. Once the player activates the start button 24 or lever 12, and the identification of the randomly selected lines, the microprocessor executes a program segment that controls the basic operation of the device. As would be understood by persons skilled in the art, this control program segment employs a random number generator, and controls the start and stop of rotation for the simulated reels 15.

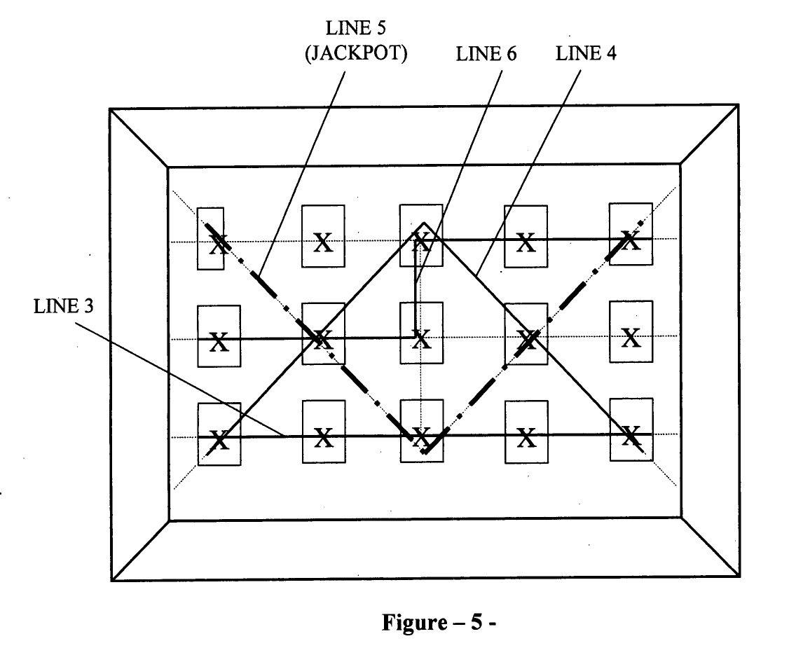

In the event that the slot machine incorporates a jackpot prize, and if the winning lines selection switch 44 is set to the random position, then the game control logic randomly assigns such jackpot to one of the winning lines. Said line is also indicated on the second LCD screen 40. FIG. 5 provides an example of the display indicated on said LCD screen 40, wherein lines 3, 4 & 6 were randomly selected and activated by the game control logic, and a jackpot prize was randomly assigned to line 5.

Upon the completion of the control program segment that checks and processes winning combinations, the control program logic returns to the program segment that determines if the player has activated the winning lines selection switch 44. Then after depositing a wager, the above described process is repeated.

It should be noted that as an additional feature, an alternate embodiment could include input control mechanism that enables a player to bet on a specific winning line without activating the random line selection, and without being constrained by the sequential order of activating lines provided by conventional machines. Such feature could be a stand alone feature, or could be combined with a random line selection feature. Also, an alternate embodiment could include an input control mechanism to enable a player to manually assign a jackpot prize to a specific winning line before the start of the game, rather than the random assignment disclosed in the preferred embodiment.

As will be understood by those skilled in the art, many different programs may be utilized to implement the flow charts disclosed in FIGS. 3 & 4. Obviously these programs will vary from one another in some degree. However, it is well within the skill of the computer programmer to provide particular programs for implementing each of the steps of the flow charts disclosed herein. It is also to be understood that the foregoing detailed description has been given for clearness of understanding only and is intended to be exemplary of the invention while not limiting the invention to the exact embodiment shown. Obviously certain modifications, variations and improvements will occur to those skilled in the art upon reading the foregoing. It is, therefore, to be understood that all such modifications, variations and improvements have been deleted herein for the sake of conciseness and readability, but are properly within the scope and spirit of the following claims.

What is claimed and desired to be secured by letters of patent is:

1. In a gaming device that employs a plurality of pay lines, means to select one or a plurality of said pay lines at random.

2. A gaming device as recited in claim 1, further comprising means to randomly assign a jackpot prize to one of said plurality of pay lines.

3. A gaming device as recited in claim 1 further comprising a housing.

4. A gaming device as recited in claim 1 further comprising an input control mechanism to enable a player to activate a feature that randomly selects pay lines.

5. A gaming device as recited in claim 3, and using mechanical reels.

6. A gaming device as recited in claim 1, and using a video display that simulates the movements of a plurality of reels.

7. A gaming device as recited in claim 1 wherein said means to select one or a plurality of pay lines at random includes an input control mechanism to enable a player to activate a control program segment that selects, and activates pay lines at random.

8. In a gaming device that includes a control program executed on a processor to control the operation of the device, and which employs a plurality of pay lines, a control program segment that selects one or a plurality of pay lines at random.

9. A gaming device as recited in claim 8 further comprising a housing.

10. A gaming device as recited in claim 9, and using mechanical reels.

11. A gaming device as recited in claim 8, and using a video display that simulates the movements of a plurality of reels.

12. A gaming device as recited in claim 8, further comprising a control program segment that randomly assigns a jackpot prize to one of said plurality of pay lines.

13. In a gaming device that includes a housing, and a control program executed on a processor to control the operation of the device, a switch that enables a player to activate a control program segment that selects one, or a plurality of pay lines at random.

14. A gaming device as recited in claim 13, and using mechanical reels.

15. A gaming device as recited in claim 13, and using a video display that simulates the movements of a plurality of reels.

16. A gaming device as recited in claim 13, further comprising a control program segment that randomly assigns a jackpot prize to one of said plurality of pay lines.

17. A gaming device as recited in claim 13, further comprising an input control mechanism to enable a player to manually assign a jackpot prize to one of a plurality of pay lines.

18. A gaming device as recited in claim 1 further comprising an input control mechanism to enable a player to assign a jackpot prize to one of said plurality of pay lines.

19. A gaming device as recited in claim 8 further comprising an input control mechanism to enable a player to assign a jackpot prize to one of said plurality of pay lines.

20. In a gaming device, a method of randomly selecting one or a plurality of pay lines, comprising the steps of:
activating a switch to enable the random line selection feature, and
randomly selecting a number of pay lines that is equivalent to the number of credits deposited by the player.
